(19) United States
(12) Patent Application Publication
(10) Pub. No.: US 2006/0254434 A1
(43) Pub. Date: Nov. 16, 2006

(54) System and method for storing food products under controlled atmospheric conditions

(75) Inventor: Owen J. Perryman, Deland, FL (US)

Correspondence Address: BEUSSE WOLTER SANKS MORA & MAIRE, P. A., 390 NORTH ORANGE AVENUE, SUITE 2500, ORLANDO, FL, 32801, US

(73) Assignee: Dade Service Corporation

(21) Appl. No.: 11/125,785

(22) Filed: May 10, 2005

(51) Int. Cl. A01J 15/14

(52) U.S. Cl. 99/467

(57) ABSTRACT

An apparatus for storing produce under controlled atmospheric conditions comprising a room in which two rows of palletized produce are positioned spaced apart from one another forming an interstitial space between the two rows and each of the two rows is spaced from sidewalls of the room forming a fluid circulation space between the sidewalls and rows of palletized produce. A partition positioned within the interstitial space divides the interstitial space into a first interstitial space and second interstitial space. An air-handling unit is operatively connected to the chamber and in fluid communication with the interstitial space and the fluid circulation space for controlling airflow between the interstitial space and fluid circulation space and across the palletized produce. The air-handling unit has a temperature control for regulating the temperature of air circulated through the first interstitial space independently from the temperature of air circulated through the second interstitial space.

### FIELD OF THE INVENTION

This invention relates generally to systems and methods for storing food products. More specifically this invention pertains to storing food products under controlled atmospheric conditions, and also pertains to such systems used to control ripening of produce.

### BACKGROUND OF THE INVENTION

Many food products are stored in rooms under controlled atmospheric conditions. Food products such as meats, dairy and bread products may be preserved and/or pre-cooled by regulating the temperature of a storage room. At least with respect to fruits and vegetables, the ripening of the produce is regulated by controlling room temperature and airflow through the room and across the produce. Such rooms are used extensively to control the ripening of bananas, and are commonly referred to as ripening rooms or banana rooms. These ripening rooms can also be used for pre-cooling of produce and other food products, in addition the ripening of produce.

Produce is typically shipped and stored in cartons having apertures through which air may circulate. The cartons are stacked on pallets, and the produce is commonly referred to as palletized produce. The palletized produce is arranged end-to-end, usually in one or two rows within the ripening room. Insulated wall panels form the room sidewalls, rear wall and ceiling. In addition, a retractable insulated door is mounted at the front of the room. The ripening rooms have an alignment structure in the form of a curb mounted on a floor of the rooms and extending along a sidewall of the room. The palletized produce is positioned within the ripening room so that the pallets abut the curb forming a space between the room sidewall and side of the palletized produce. In the case of two rows of produce, a ripening room has a curb positioned in the center of the room and/or on each side of the room extending along a respective sidewall. Two rows of produce are positioned in the room, with each row of palletized produce abutting the central curb forming an interstitial space between the two rows of palletized produce. In addition, each of the two rows of produce is spaced from a respective sidewall forming a fluid circulation space between the sidewalls and sides of the palletized produce.

A fluid control unit or air-handling unit, that includes one or more circulation fans, is connected to the room, and positioned within a room to circulate air between the interstitial space and fluid circulation space. Sealing members and/or baffles are positioned within the room to direct the flow of air through the holes in the cartons and across the produce. For example, the rooms known as “tarped” rooms utilized a tarpaulin that is draped over the top and front of the produce to seal the interstitial space from the space between the sidewalls and produce. Air is drawn from the interstitial space and circulates into the space between the sidewalls and produce and forced through the cartons across the produce. When air is drawn from the sealed interstitial space a low-pressure plenum is created, and air flows through the circulation space, and across the produce back to the interstitial space.

Other systems, known as “tarpless” rooms, have used one or more baffles positioned in sealing relationship against the produce either at the interstitial volume or between the produce and side walls to seal the interstitial space from the space between the produce and the sidewalls. Depending on where the baffles may be located in the room, a fluid control unit is positioned to draw air from, or inject air into the interstitial space or inject air into the fluid circulation space.

Ripening rooms also include means for regulating the temperature of air in the room, which often includes one or more cooling coils, as part of the air-handling unit adjacent the circulation fans. As produce ripens, it generates heat. Accordingly, air within the ripening room is conditioned in order to control the rate at which the produce shall ripen. Some ripening rooms have two cooling coils that are positioned in the room to cool air circulated on opposite sides of the room at different rates. In this manner, produce can be ripened at two different rates at the same time in the same room.

### SUMMARY OF THE INVENTION

The present invention for a system for storing produce under controlled atmospheric conditions, comprises a chamber having a floor, ceiling, two sidewalls, a rear wall and a door positioned toward a front of the chamber opposite the rear wall. An alignment structure is disposed within the chamber for positioning produce in the chamber in two rows spaced apart from each other forming an interstitial space, at least a portion of which is between the two rows of produce. Each of the two rows are spaced from the sidewalls forming a fluid circulation space at least a portion of which is between the sidewalls and the two rows of produce.

A sealing means is positioned along a front end of the produce and along a top of the produce at the interstitial space, for sealing the interstitial space from the fluid circulation space. A partition, positioned within the interstitial space, is operably connected to the sealing means and divides the interstitial space into a first interstitial space and a second interstitial space.

An air-handling unit is operatively connected to the chamber and in fluid communication with the first and second interstitial spaces, and the fluid circulation space, for controlling airflow between the interstitial spaces and fluid circulation space and across the produce. In an exemplary embodiment, the air-handling unit is equipped with a temperature control for regulating the temperature of fluid circulated through the first interstitial space independently from the temperature of fluid circulated through the second interstitial space.

### BRIEF DESCRIPTION OF THE DRAWINGS

The features and advantage of the present invention will become apparent from the following detailed description of the invention when read with the accompanying drawings.

FIG. 1 is a perspective view of an embodiment of the invention in a two-tier ripening room.

FIG. 2 is a front view of an embodiment of the invention in a two-tier ripening room illustrating airflow direction.

FIG. 3 is a front view of an embodiment of the invention in a two-tier ripening room illustrating airflow direction.

FIG. 4 is perspective view of an embodiment of the invention in a single-tier ripening room.

FIG. 5 is a front view of an embodiment of the invention in a single-tier ripening room illustrating airflow direction.

FIG. 6 is a front view of an embodiment of the invention in a three-tier ripening room illustrating airflow direction.

FIG. 7 is a sectional view taken along line 7-7 in FIG. 1.

FIG. 8 is a sectional view of an air-handling unit in an embodiment of the invention.

FIG. 9 is a sectional view of an air-handling unit in an embodiment of the invention.

FIG. 10 is a perspective of an embodiment of the invention in a ripening room in which a tarp seals the interstitial space.

FIG. 11 is a sectional view of a ripening room incorporating an embodiment of the invention in a ripening room in which a tarp seals the interstitial space.

FIG. 12 is a perspective view of a back end of a ripening room in which a tarp seals the interstitial space.

FIG. 13 is a front sectional view of a ripening room incorporating an embodiment of the invention, taken along line 13-13 in FIG. 14.

FIG. 14 is a side sectional view of the ripening room taken along line 14-14 in FIG. 13 and illustrates the direction of airflow in the ripening room.

FIG. 15 is a sectional top view of the ripening room taken along line 15-15 in FIG. 13 and illustrates the direction of airflow in the ripening room.

### DETAILED DESCRIPTION OF THE DRAWINGS

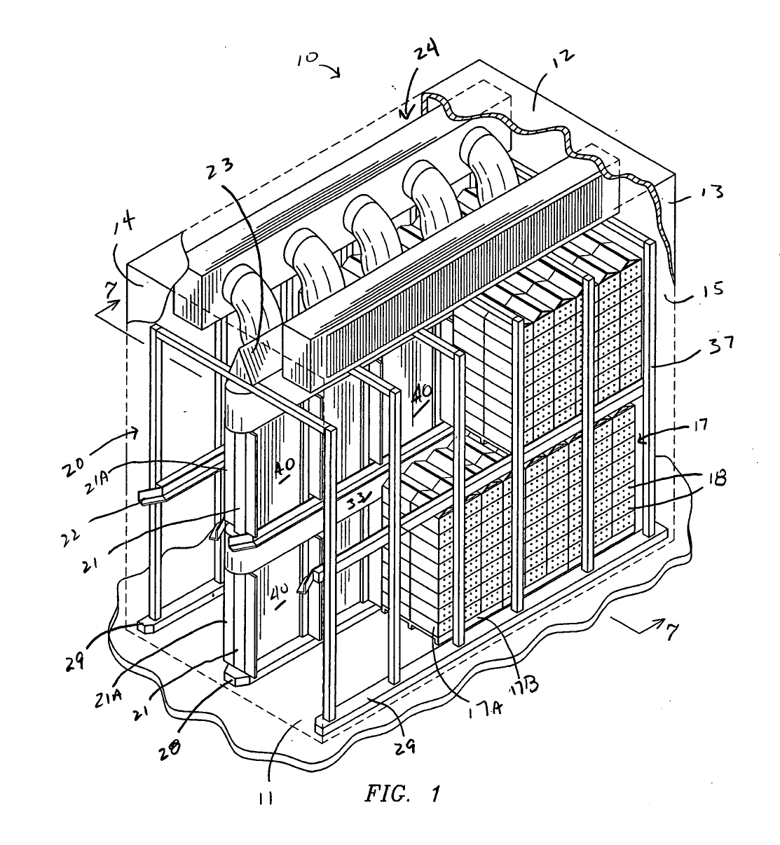

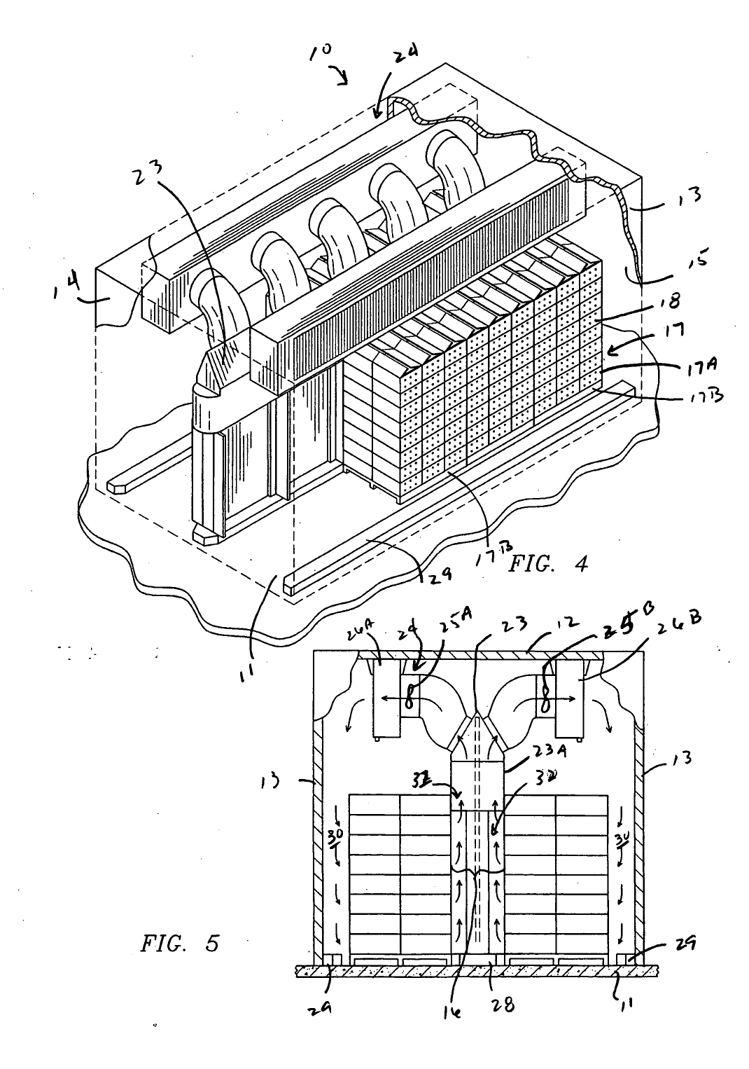

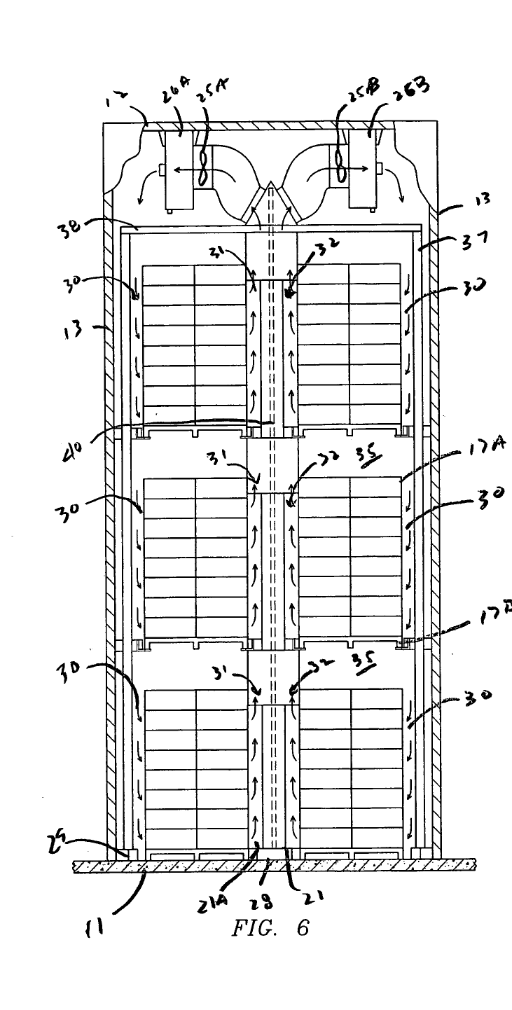

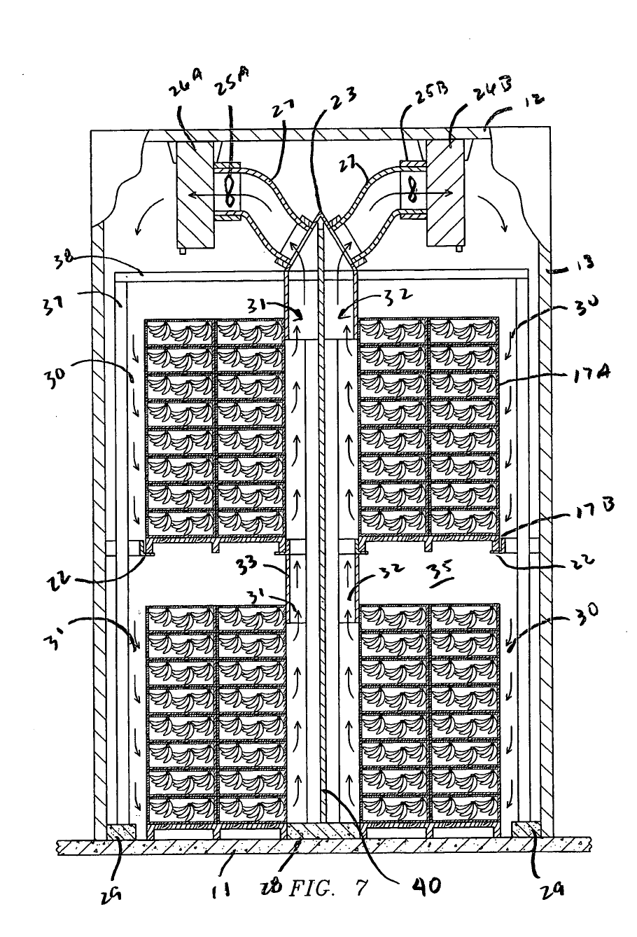

An exemplary embodiment of the present invention is illustrated in FIGS. 1, 2, 3 and 7, and depicts the system incorporated in a two-tier ripening room. However, the present invention is not limited to use in a two-tier ripening room, but can be used in a single-tier room as shown in FIGS. 4 and 5, and in other multi-tier as shown in FIG. 6. Moreover, the produce stored in the rooms is not limited to bananas; the invention is intended for use for any type of foods that require storage under atmospheric controlled conditions. The produce stored within the rooms is arranged in two rows spaced apart from one another forming an interstitial space between the rows. In addition, each of the rows is spaced from a sidewall forming a fluid circulation space between the sidewalls of the ripening room and the stored produce.

In as much as a difference in the ripening rooms depicted in FIGS. 4, 5 and 6, is the number of tiers of palletized produce in a respective ripening room, the below description of the ripening rooms shown in FIGS. 1, 2, 3 and 7 shall apply to the ripening rooms depicted in FIGS. 4, 5 and 6. Like parts in the respective rooms in FIGS. 4, 5 and 6 are labeled with the same numerals as used in FIGS. 1, 2, 3 and 7.

With respect to FIGS. 1, 2, 3 and 7, a ripening room 10 is illustrated having a floor 11, ceiling 12, two sidewalls 13, a front wall 14 and a rear wall 15. A door (not shown) is mounted on the front wall 14, and is opened and closed for placing produce in the room 10, or removing produce from the room 10. All the above-identified walls 13, 14 and 15 are preferably constructed using insulated panels, which are commonly used in the construction of food storage facilities. In addition, the door is preferably constructed from one or more insulated panels. Other materials and methods for construction the walls 13, 14 and 15, and the door known to those skilled in the art, may be used to provide sufficient insulation to the room in order to control the temperature within the room.

Palletized produce 17 is shown positioned within the ripening room 10. Palletized produce refers to the cartons 17A in which the produce is stored. The cartons 17A are stacked on pallets 17B, which are supported by the floor 11 and, as explained below on a frame structure 20. The cartons have apertures 18 on their sides so air may flow through the cartons 17A and over the produce stored within cartons 17A.

An alignment structure is preferably mounted within the room for positioning two rows of palletized produce in the room. The alignment structure shown in FIGS. 1, 2, 3 and 7 includes at least one curb 28 positioned centrally within the room 10. The alignment structure may also include curbs 29 positioned on the floor 11, adjacent to and extending along the sidewalls 13. The alignment structure could alternatively be lines formed on the floor. While an alignment structure is preferred it is not required, as long as the palletized produce 17 is positioned in the room as described above.

The palletized produce 17 is positioned in the room 10 on the floor 11 so the pallets 17A are adjacent to, or abutting, the centrally located curb 28 forming two rows of palletized produce 17 that are spaced apart from one another forming an interstitial space 16 between the two rows of palletized produce 17 and a fluid circulation space 30 at least a portion of which is between each row of palletized produce 17 and a respective sidewall 13 of the room 10. The fluid circulation space 30 may also be interpreted to include that space above the top of the palletized produce 17, in front of the palletized produce 17 or behind the palletized produce 17.

In addition, the alignment structure shown in FIGS. 1, 2, 3 and 7 includes a frame structure 20 that supports an upper tier of palletized produce 17 above a lower tier, which is supported by the floor 11. The frame structure 20 includes vertical frame members 37 and horizontal frame members 38 to which parts of the system are attached. Rails 22 are mounted to vertical frame members 38 and support the upper tier of palletized produce 17 spaced above the lower tier of palletized produce 17 forming a space 35 between the lower tier and upper tier of palletized produce 17. The rails 22 are aligned with the curbs so the two rows of palletized produce 17 in the upper tier are spaced apart from one another so the interstitial space 16 between the two rows of produce extends at least from the floor 11, or top of curb 28, to a top end of the upper tier of the palletized produce 17.

A sealing means is positioned along a front end and back end of the palletized produce 17 and along a top of the palletized produce 17 at the interstitial space 16, for sealing the interstitial space 16 from the fluid circulation space 30. For purposes of describing the invention, front shall refer to that portion of the room or palletized produce 17 that is closest to the front wall 14 and door, and back or rear shall refer that portion of the room 10 or palletized produce 17 that is closest to the rear wall 15.

The sealing means illustrated in FIGS. 1, 2, 3 and 7 includes a baffle 21 positioned between the two rows of palletized produce 17 at a front end of the palletized produce 17 that abuts an inside edge of the pallets 17B and/or cartons 17A in which the produce is stored. The baffle 21 is preferably constructed from a twelve gauge galvanized steel sheet metal and may include a flexible member 21A to contact the cartons 17A and flex to conform to the alignment of cartons 17 and form a seal between the baffle 21 and palletized produce 17. The baffle 21 extends at least from a bottom of the cartons 17A to top end of cartons 17A. In addition, a baffle 21 is positioned at the rear end of the palletized produce 17. As explained in more detail below a top baffle 23 is positioned above, or along a top end of the palletized produce 17 at the interstitial space 16, in sealing relationship with the palletized produce 17, to seal the interstitial space 16 from the fluid circulation space 30.

In the embodiments illustrated in FIGS. 1-7, the system includes a plurality of baffles 21 positioned within the interstitial space 16. A baffle 21 is positioned at a respective front end and back end of each pallet 17B in both the upper tier and lower tier of palletized produce 17. In this manner, the interstitial space 16 remains sealed when room is not filled with palletized produce 17, and does not require the movement of tarps for sealing the interstitial space 16. Alternatively, fewer baffles 21 may be used. For example, the baffles may be positioned between every fifth pallet in a room that can hold up to twenty pallets deep of produce.

However, the system may be operable if it includes only two baffles 21 with one baffle 21 positioned toward a front end of the room and another positioned toward a back end of the room. In some instances the interstitial space 16 may sealed by abutting the back end of a row of palletized produce against the rear wall 15, or against a pressure wall when the present invention is utilized in a “tarped” room as will be described in more detail below.

With respect to the two-tier rooms shown in FIGS. 1 through 3, and the three-tier room in FIG. 6, the interstitial space 16 is sealed from the fluid circulation space 30 by sealing members 33 at the space 35 between the upper tier and the lower tier of the palletized produce. In multi-tier ripening rooms, the interstitial space 16 may be interpreted to include the space 35 between the upper tier and lower tier of palletized produce 17.

In an exemplary embodiment, the sealing members 33 extend along an inside edge of the palletized produce 17 and depend from rails 22 and/or are mounted to vertical frame members 37 positioned in the interstitial space 16. Alternatively, the sealing members 33 may also be positioned on an outside edge of the palletized produce 17 and depending from rails 22 and/or are mounted to the frame members 37 positioned in the fluid circulation space 30. The sealing members 33 may be constructed of any material that can either seal the space 35 from the fluid circulation space 30 such as wood, sheet metal or from a flexible tarpaulin material.

An air-handling unit 24 is operatively connected to the room 10 to either inject air into or withdraw air from the interstitial space 16, and thereby create a pressure differential between the interstitial space 16 and the fluid circulation space 30. In this manner, conditioned air will flow across produce in the cartons 17A to control the rate at which the produce ripens or cools. The air-handling unit 24 illustrated herein is shown mounted within the ripening room, but such units may be positioned outside of the room and in fluid communication with an interior of the room.

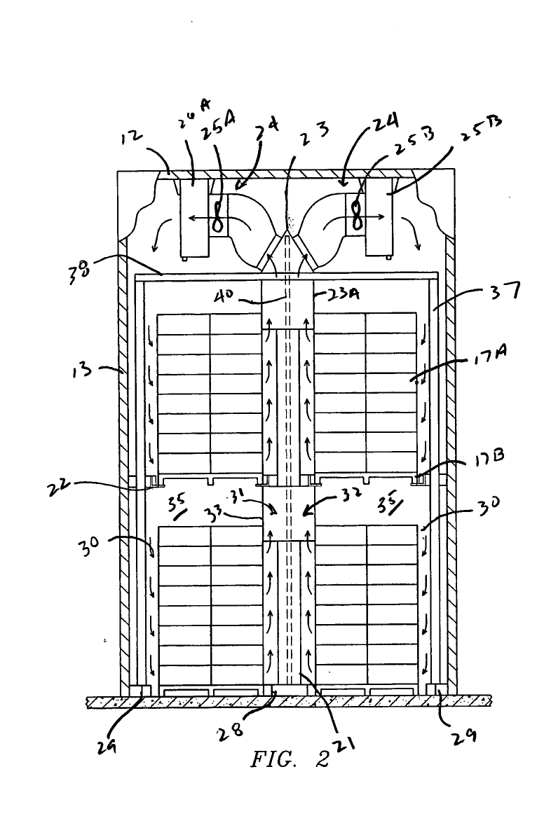

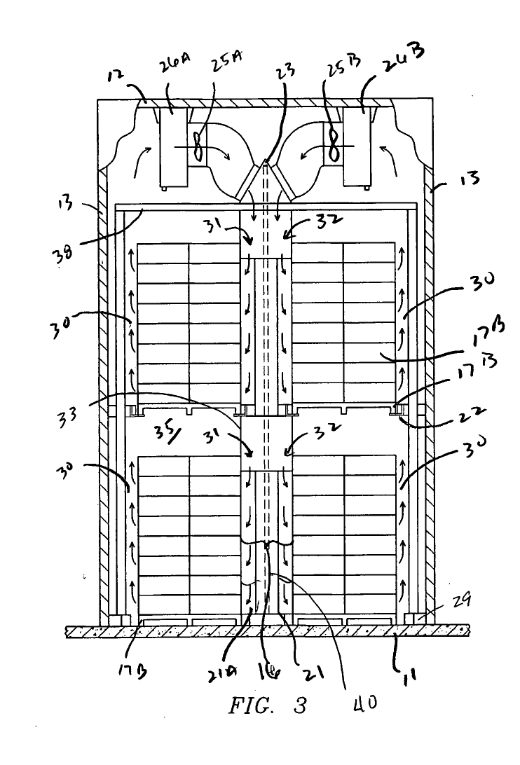

A partition 40 is mounted to the frame structure 20 within the interstitial space 16 and divides the interstitial space 16 into a first interstitial space 31 and a second interstitial space 32. The air-handling unit 24 is in fluid communication with the first interstitial space 31 and the second interstitial space 32 so that air flows in the direction as indicated by the arrows in FIG. 2, when the air-handling unit 24 draws air upward from the interstitial space 16. Air may flow in an opposition direction as shown in FIG. 3, when the air-handling unit 24 injects or forces air into the interstitial spaces 31 and 32.

The partition 40 may be constructed of one or more components to divide the interstitial space 16. With respect to FIG. 2, a plurality of partitions 40 is used to divide the interstitial space 16. At least one partition 40 is mounted to the frame structure 20 between consecutive baffles 21 and between the upper tier and lower tier of palletized produce 17. In the exemplary embodiment shown in FIGS. 1, 2, 3 and 7, the partition 40 extends from the floor 11 or curb 28 to a top baffle 23, so the first interstitial space 31 is sealed from the second interstitial space 32. The partition can be constructed from a variety of building materials including sheet wood products such as plywood or particleboard, sheet metal or tarpaulin.

A top baffle 23 is operatively connected to the room 10 to seal a top end of the interstitial space 16. The top baffle 23 preferably extends from a front end of the palletized produce 17 to a back end of the palletized produce 17. The top baffle 23 may include side seals 23A that extend downward along a side of the palletized produce at the interstitial space 16. The top baffle 23 has two inclined members as shown in FIGS. 2, 3 and 7, and ducts 27 are connected to the air handling unit 24 and inclined members of the baffle 23 to direct air flow into or out of the first interstitial space 31 and second interstitial space 32.

The exemplary air-handling unit 24 includes a first set of one or more fans 25A and one or more air coolers 26A in fluid communication with the first interstitial space 31, and a second set of one or more fans 25B and one or more air coolers 26B in fluid communication with the second interstitial space 32. The first set of air coolers 26A may be controlled independent of the second set of air coolers 26B thereby regulating the temperature of the air flowing through the first interstitial space 31 independently of temperature of the air flowing through the second interstitial space 32. In this manner, the produce positioned on one side of the partition 40 can be ripened at a different rate than produce positioned on the other side of the partition 40. In addition, the set of fans 25A and 25B may be controlled independent of the of one another, and the fans within a respective set 25A or 25B may be controlled independent of one another so that the room can operate when the room is less than full of the palletized produce 17.

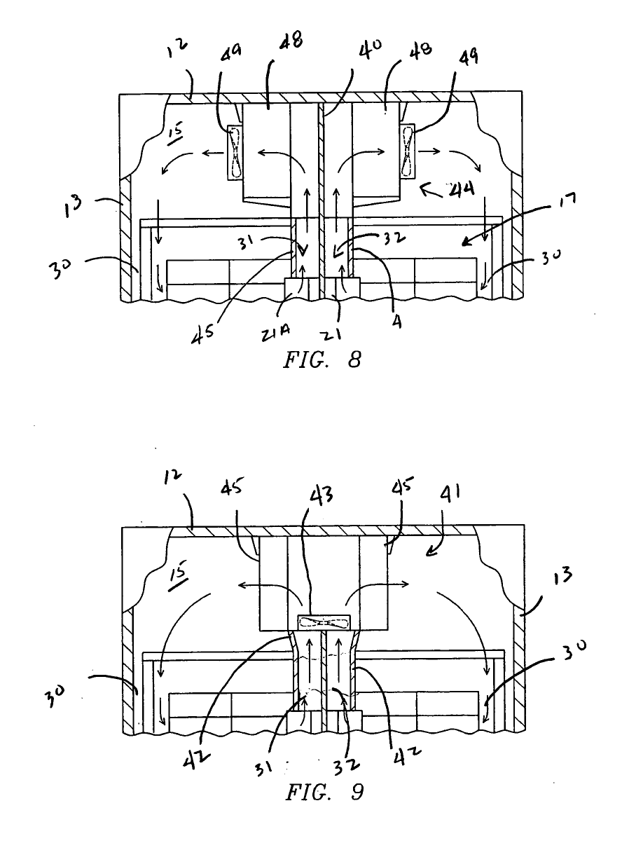

With respect to FIGS. 8 and 9, embodiments illustrate different interconnections of an air-handling unit with the first interstitial space 31, the second interstitial space 32 and the partition 40. The partition 40 extends upward from the interstitial space 16 to a predetermined height above the top of the palletized produce 17 and the air-handling unit 44 is mounted in the room in fluid communication with the interstitial space 16. In the exemplary embodiment illustrated in FIG. 8, the partition 40 extends upward from the interstitial space 16 to the ceiling 12 of the ripening room 10. The air-handling unit 44 includes an air cooler 48 and one or more fans 49 mounted in the room on each side of partition 40. Top baffles 45 extend from the bottom of the air-handling unit 44 and include the side seals 45A to seal the interstitial spaces 31 and 32 from the fluid circulation space 30.

In FIG. 9, an air-handling unit 41 is mounted to the room having one or more fans 43 positioned directly above the interstitial space 16, to draw air from, or inject air into the first interstitial space 31 and second interstitial space 32. One or more air coolers 45 are positioned on each side of the fans 43. The partition 40 extends upward to a bottom of the air-handling unit 41. Top baffles 42 depend from the bottom of the air-handling unit 41 and include the side seals 42A that abut against a portion of the side of the palletized produce 17 along the interstitial spaces 31 and 32 to seal the interstitial spaces 31 and 32 from the fluid circulation 30.

Alternatively, in each of the above referenced embodiments illustrated in FIGS. 8 and 9, a horizontally disposed baffle (not shown) may be mounted on the frame structure 20 above the interstitial space 16 and connected to the side seals 33 sealing the interstitial space 16 from the fluid circulation space 30. One or more ducts (not shown) associated with respective fans 43 and 49 may depend from the bottom of the air-handling units 41 and 44 for fluid communication between the air-handling unit 41 and the interstitial spaces 31 and 32.

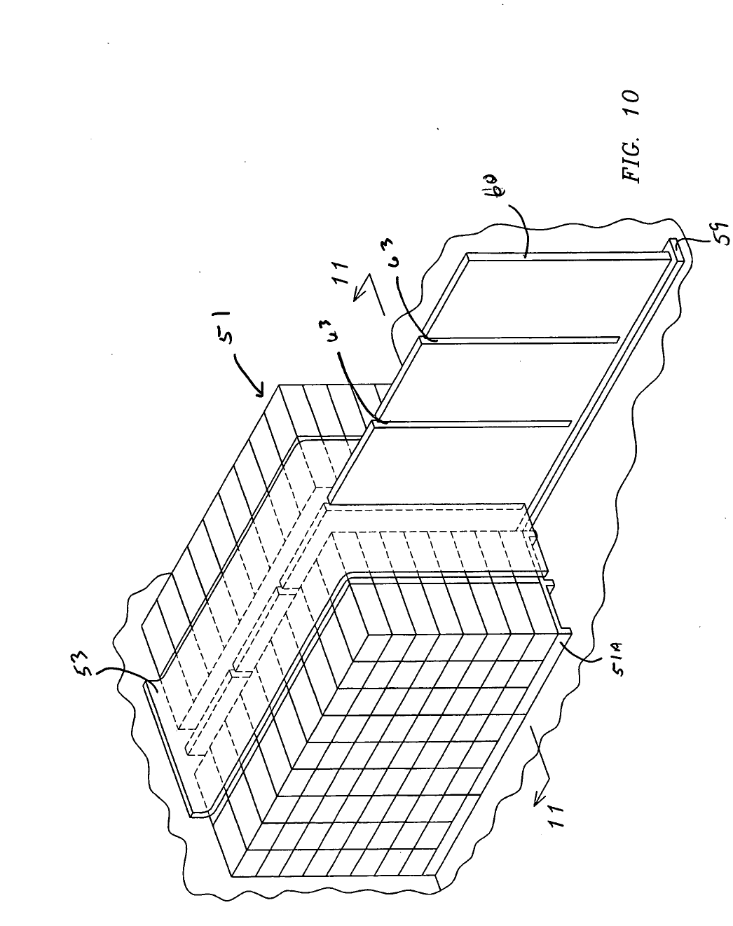

With respect to FIGS. 10, 11 and 12, the system is shown incorporated with a “tarped” single-tier room, which includes a floor 67, ceiling 68, rear wall 55, two sidewalls 56 and a front wall 57 with a door (not shown). This embodiment may also be incorporated in a multi-tier “tarped” room. An alignment structure including a centrally located curb 59 spaces the two rows of palletized produce 51 apart forming the interstitial space 54, and the rows of palletized produce 51 are spaced from the sidewalls 56 forming the fluid circulation space 58 between the sidewalls 56 and the palletized produce 51.

The sealing means includes a tarp 53 that is rolled over the top and front of the palletized produce 51, and a “pressure” wall 50 positioned at the rear of the palletized produce 51, to seal the interstitial space 54 from the fluid circulation space 58 between the sidewalls 56 and rows of palletized produce 51.

A partition 60 is mounted in the ripening room between the two rows of palletized produce 51, dividing the interstitial space 54 into a first interstitial space 62 and a second interstitial space 63. The partition 60 has a plurality of gaps 63 wherein each gap 63 is positioned on the partition 50 adjacent each location where consecutive pallets 51A of the palletized produce 51 abut one another. In this manner, the tarp 53 can be draped over the front of the palletized produce 51, through a respective gap 63 when pallets 51A are removed, or the room contains less than a full allotment of palletized produce 51. The partition 60 may be a single piece of material with gaps 63 or a plurality of partitions separated by gaps 63. The gaps 63 need only be a few inches wide for insertion of the tarp 53.

An air-handling unit is operatively connected to the room to draw air from the interstitial space 54 and inject conditioned air into the fluid circulation 58. The air-handling unit is preferably mounted in the room between the rear wall 55 and the “pressure” wall 50. The air-handling unit preferably includes at least one fan 64 mounted to the pressure wall 50 in fluid communication with the interstitial spaces 62 and 63 to draw air from the first interstitial space 62 and second interstitial space 63. The embodiment illustrated in FIGS. 10, 11 and 12 includes fans disposed on each side of the partition 60.

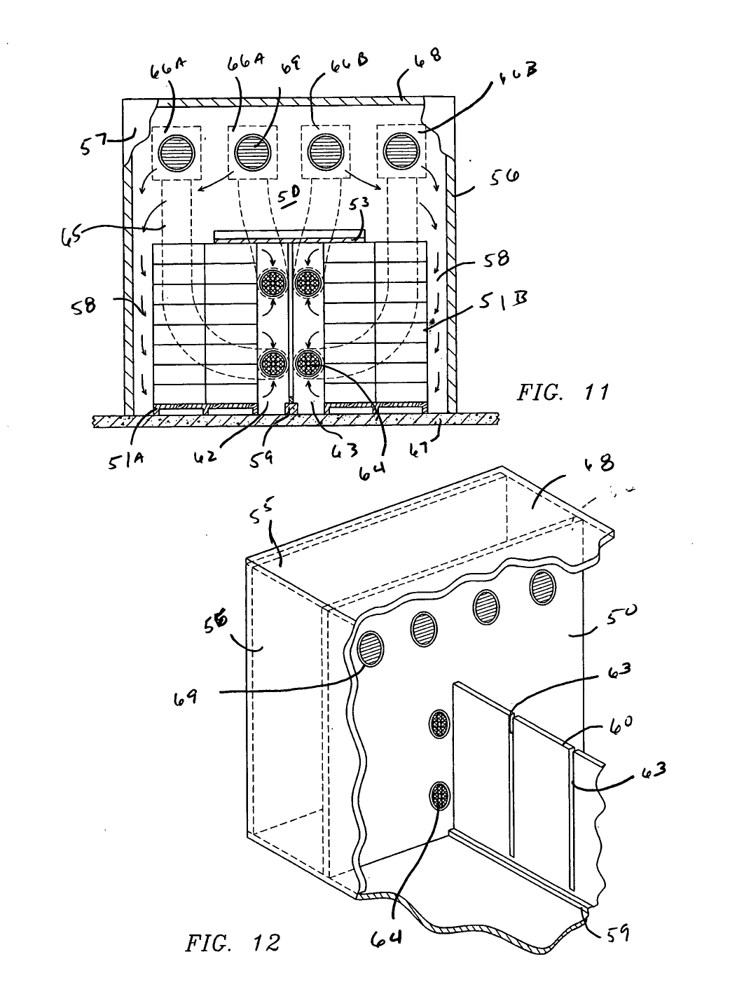

In operation, the fans 64A and 64B draw air from interstitial spaces 62 and 63, which air passes through air coolers 66A and 66B respectively. Air drawn from the first interstitial space 62 is preferably isolated from the air drawn from the second interstitial space 63 by ducts 65 mounted to the fans 64 and the air coolers 66A and 66B. Conditioned air exiting the air coolers 66A and 66B through exhaust openings 69 and is injected to the fluid circulation space 58 as shown in FIG. 11, and passes through the cartons 51B over the produce to the interstitial spaces 62 and 63.

When ducts 65 are used, the pressure wall 50 is not required to extend from sidewall to sidewall 56, or to the ceiling 68 of the room. The pressure wall 50 need only be large enough to seal the back end of the interstitial spaces 62 and 63, and support the fans. Ducts are not required if the pressure wall 50 extends the full height of the room. In such a case, the partition 60 may be extended to the rear wall 55 and the height of the room to isolate air exhausted from the respective interstitial spaces 61 and 62.

Similar to the previously described embodiments, the air coolers 66A and 66B are operable independent of one another. The air cooler 66A is capable of regulating the temperature of air passing through interstitial space 62 independent of the air cooler 66B regulating the temperature of air passing through the interstitial space 63. Moreover, the partition 60 isolates the airflow through the first interstitial space 62 from airflow through the second interstitial space 63. In this manner, produce in one row of the palletized produce on one side of the partition 60 can be ripened at a different rate than produce in the second row of palletized produce on the other side of the partition.

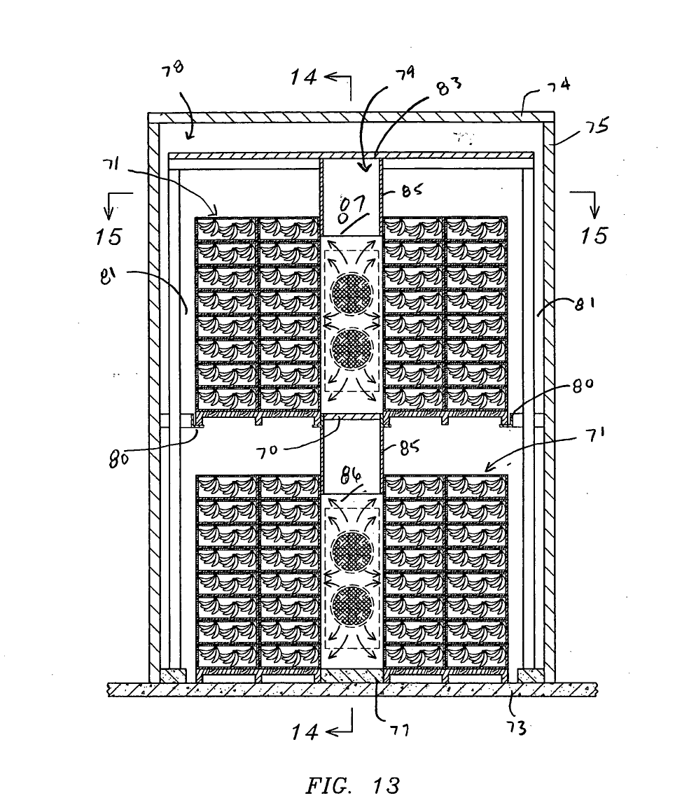

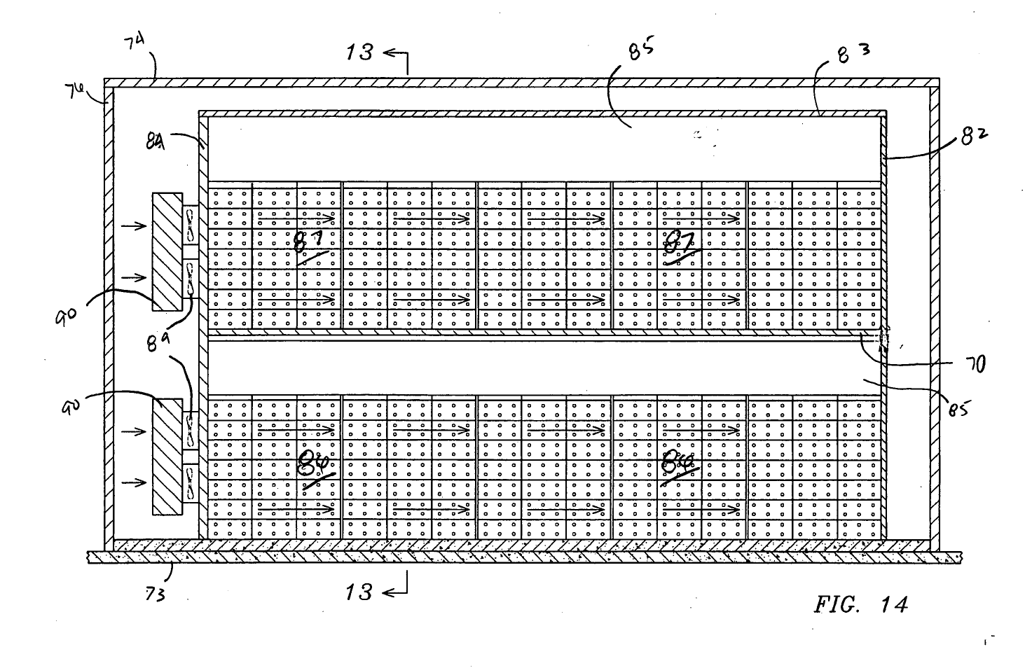

Another embodiment is illustrated in FIGS. 13 and 14, and a partition 70 is horizontally disposed between an upper tier and lower tier of palletized produce 71. The room 72 includes a floor 73, ceiling 74, sidewalls 75 and rear wall 76. An alignment structure including a central curb 77 and frame structure 78 position the palletized produce 71 in two rows spaced apart from one another forming an interstitial space at least a portion of which is between the two rows of palletized produce 71. In addition, the two rows of palletized produce are spaced from the sidewalls 75 forming a fluid circulation space 81 at least a portion of which is between the sidewalls 75 and each of the two rows of palletized produce 71. The frame structure 78 has rails 80 that support an upper tier of palletized produce 71 spaced above a lower tier of palletized produce 71 on the floor 73.

A partition 70 is horizontally disposed within the interstitial space 79 and extends from a front end of the palletized produce 71 to a back end of the palletized produce 71. The partition 70 is mounted to the frame structure 78 adjacent the rails 80 and preferably adjacent a bottom end of the palletized produce 71.

The sealing means for sealing the interstitial space 79 from the fluid circulation space 81 includes a first baffle 82 mounted to the frame structure 78 at a front end of the palletized produce 71 to cover and seal the interstitial space 79. The first baffle 82 need only be wide enough to cover the interstitial space at the front end of the palletized produce 71. A second baffle 83 mounted on the frame structure 78 adjacent to or above a top end of the palletized produce 71 to seal a top end of the interstitial space 79. A third baffle 84 mounted to the frame structure 78 and positioned at a back end of the palletized produce. The third baffle 84 may be wide enough to cover the entire width of the two rows of palletized produce 71, or only wide enough to cover the interstitial space 79. Each of the baffles 82, 83 and 84 may have flexible strips as described above to seal against a side of the palletized produce.

In an exemplary embodiment, side sealing members 85 depend from the second baffle 83 and rails 80 to seal the interstitial space 79 at the top end of the palletized produce 71 and between the upper tier and lower tier of palletized produce 71. The baffles may be constructed of the materials previously described. In the case of tarpaulin material, the tarp may have to be affixed to the frame structure if air is injected into the interstitial space 79 in order to maintain an effective seal between the interstitial space 79 and the fluid circulation space 81.

The partition 70 is horizontally disposed within the interstitial space 79 dividing it into a first interstitial space 86 between the upper tier of two rows of palletized produce and a second interstitial space 87 between the lower tier of two rows of palletized produce.

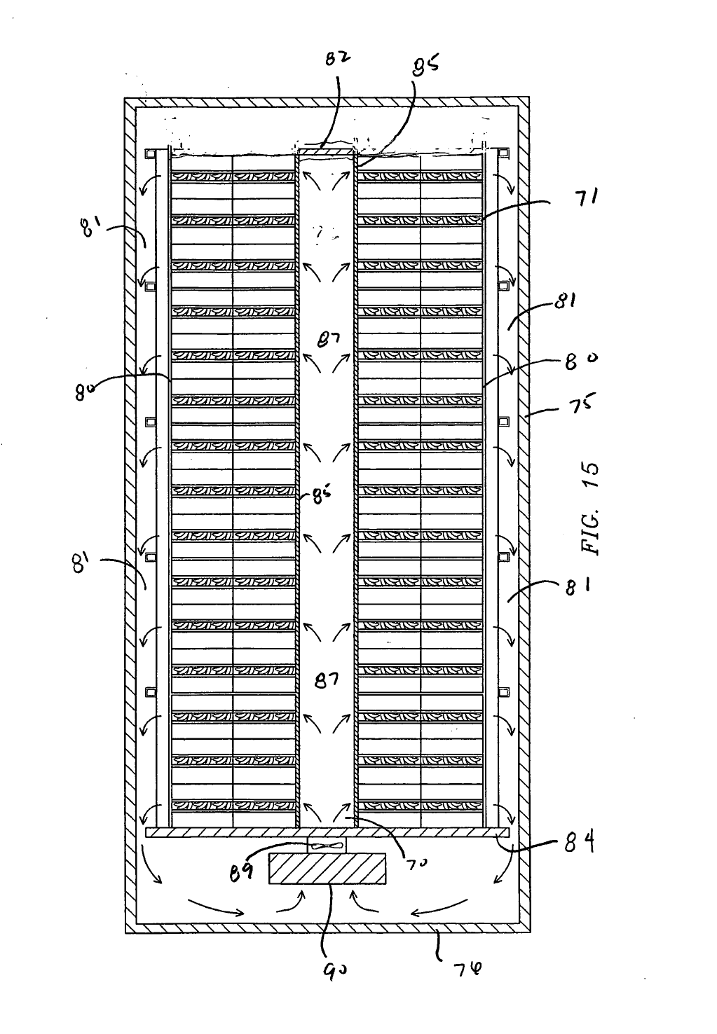

In FIGS. 14 and 15, an air-handling unit 88 is connected to the room, in fluid communication with the interstitial space 79, by injecting air into the interstitial space 79 at the back end of the palletized produce 71. The air-handling unit 88 includes fans 89 and air-coolers 90. The fans 89 and air-coolers 89 are positioned in fluid communication with the first interstitial space 86 and the second interstitial space 87. In this embodiment, air is injected into the interstitial space at the back end of the palletized produce 71, creating a high-pressure area in the interstitial spaces 86 and 87 with respect to a low-pressure area in the fluid circulation space 81. Air flows into and through the interstitial spaces 86 and 87, across the palletized produce 71 to the fluid circulation space 81. The air then flows to the back end of the room 72 through the air coolers 90 and fans 89 where it is reintroduced to the interstitial spaces 86 and 87.

The air-handling unit 88 has a temperature control so that the air-coolers 90 operate independently from one another. In this manner, the air-coolers 90 and fans 89 can cool the air flowing into the interstitial spaces 86 and 87 at different rates and thereby cool and ripen the palletized produce 71 in the upper tier at different rate with respect to the palletized produce 71 in the lower tier.

The room 72 may be operated to control airflow in the opposition direction as described above, but may not achieve as an effective temperature differential between the air flowing from the fluid circulation space 81 across the produce 71 and into the respective interstitial spaces 86 and 87. When air is drawn from the interstitial spaces 86 and 87, and cooled by air coolers 90, the air flowing from the air coolers 90 and the respective interstitial spaces 86 and 87 may mix before passing across through palletized produce. Accordingly, the temperature difference between air passing across the palletized produce 71 in the upper tier and lower tier may be decreased; thereby, effecting the difference at which the produce with respect to the upper tier and lower tier.

While the preferred embodiments of the present invention have been shown and described herein, it will be obvious that such embodiments are provided by way of example only and not of limitation. Numerous variations, changes and substitutions will occur to those of skilled in the art without departing from the teaching of the present invention. Accordingly, it is intended that the invention be interpreted within the full spirit and scope of the appended claims.

What I claim as my invention is:

1. An apparatus for storing produce under controlled atmospheric conditions, comprising:
a room having a floor, ceiling, two sidewalls, a rear wall and a door positioned on an end of the room opposite the rear wall wherein palletized produce is positioned in two rows spaced apart from each other forming an interstitial space, at least a portion of which is between the two rows of palletized produce, and each of the two rows being spaced from the sidewalls forming a fluid circulation space at least a portion of which is between the sidewalls and the two rows of produce;
sealing means, positioned along a front end of the palletized produce, a top of the palletized produce and a back end of the palletized produce at the interstitial space, for sealing the interstitial space from the fluid circulation space;
a partition, positioned within the interstitial space that divides the interstitial space into a first interstitial space and a second interstitial space;
an air-handling unit operatively connected to the chamber and in fluid communication with the first interstitial space, the second interstitial space and the fluid circulation space for controlling air flow between the interstitial spaces and fluid circulation space and across the produce; and,
said air-handling unit having a temperature control for regulating the temperature of air circulated through the first interstitial space independently from the temperature of air circulated through the second interstitial space.

2. The apparatus of claim 1 wherein the partition is vertically disposed within the interstitial space and extends from the floor of the room to at least a top end of the palletized produce.

3. The apparatus of claim 1 further comprising an alignment structure for positioning the palletized produce in two rows spaced apart from each other forming the interstitial space, at least a portion of which is between the two rows of palletized produce, and each of the two rows being spaced from the sidewalls forming a fluid circulation space at least a portion of which is between the sidewalls and the two rows of palletized produce.

4. The apparatus of claim 1 wherein the alignment structure comprises a curb mounted to the floor of the room and centrally positioned within the room and a row of palletized produce is positioned on each side of the curb.

5. The apparatus of claim 1 wherein the alignment structure comprises a frame structure that supports an upper tier of two rows of palletized produce above a lower tier of two rows of palletized produce and forming space between the upper tier and lower tier of palletized produce, and the two rows of palletized produce, in the upper tier and lower tier, are spaced apart from one another forming the interstitial space, and the two rows of produce, in the upper tier and lower tier, are spaced from the sidewalls forming the fluid circulation space.

6. The apparatus of claim 5 wherein the partition is vertically disposed within the interstitial space and extends at least from a bottom of the palletized produce to a top of the palletized produce, and extends a length of the two rows of produce.

7. The apparatus of claim 5 wherein the partition is horizontally disposed, extends at least from a front end of the palletized produce to a back end of the palletized produce and is positioned in the interstitial space adjacent to a bottom end of the upper tier of two rows of palletized produce.

8. The apparatus of claim 7 wherein the sealing means comprises a first baffle at a front end of the palletized produce and a second baffle at a top end of the upper tier of palletized produce at the interstitial space and a third baffle positioned at a back end of the palletized produce at the interstitial space.

9. The apparatus of claim 8 wherein third baffle has two side edges extending from a front end of the palletized produce to a back end of the palletized produce and a sealing member depending from each side edge of the third baffle and the adjacent a portion of a surface of the palletized produce at the interstitial space.

10. The apparatus of claim 1 wherein the air-handling unit comprises a first set of one or more fans in fluid communication with the first interstitial space and a second set of one or more fans in fluid communication with the second interstitial space, a first air cooler for regulating temperature of air flowing through the first interstitial space and a second air cooler for regulating temperature of air flowing through the second interstitial space.

11. The apparatus of claim 1 wherein the air-handling unit comprises at least one fan positioned over the interstitial space and in fluid communication with the interstitial space, and a first air cooler for regulating temperature of air flowing through the first interstitial space and a second air cooler for regulating temperature of air flowing through the second interstitial space.

12. The apparatus of claim 1 where in the sealing means comprises a first baffle positioned along a front end of the produce between the two rows of palletized produce and extending from the floor of the room to a top end of the palletized produce, a second baffle positioned along a back end of the palletized produce between the two rows of palletized produce extending from the floor of the room to a top end of the palletized produce a third baffle positioned in sealing relationship with a top end of the palletized produce and the air handling unit.

13. The apparatus of claim 12 wherein the sealing means further comprises a plurality of baffles positioned in the interstitial space between the two rows of produce and each baffle extends from the floor of the ripening room to a top end of the palletized produce and is positioned at a respective front end and back end of each pallet of the palletized produce.

14. The apparatus of claim 12 wherein the third baffle has two parallel side edges extending from a front end of the palletized produced to a back end of palletized produce and a sealing member depending from each side edge of the third baffle and adjacent a portion of a surface of the palletized produce at the interstitial space.

15. The apparatus of claim 1 wherein the sealing means comprises one or more tarpaulin on a top end of the palletized produce and over a front end of the palletized produce and a pressure wall spaced from the rear wall adjacent to a back end of the palletized produce, and wherein the air-handling unit is positioned between the rear wall of the room and the pressure wall.

16. An apparatus for storing produce under controlled atmospheric conditions, comprising:
a chamber having a floor, ceiling, two sidewalls, a rear wall and a door positioned toward a front of the chamber opposite the rear wall;
an alignment structure disposed within the chamber for positioning produce in the chamber in two rows spaced apart from each other forming an interstitial space, at least a portion of which is between the two rows of produce, and each of the two rows being spaced from the sidewalls forming a fluid circulation space at least a portion of which is between the sidewalls and the two rows of produce;
sealing means, positioned along a front end of the produce, a top of the produce and the back end of the produce at the interstitial space, for sealing the interstitial space from the fluid circulation space;
a partition, vertically disposed within the interstitial space that extends from a bottom end of the palletized produce to a top end of the palletized produce and from a front end of the palletized produce to a back end of the palletized produce and divides the interstitial space into a first interstitial space and a second interstitial space; and,
an air-handling unit operatively connected to the chamber and in fluid communication with the first interstitial space, the second interstitial space and the fluid circulation space for controlling fluid flow between the interstitial space and fluid circulation space and across the palletized produce.

17. The apparatus of claim 16 wherein the air-handling unit comprises one or more fans in fluid flow communication with the first interstitial space and the second interstitial space and a temperature control for regulating the temperature of fluid flow through the first interstitial space independently from regulating the temperature of fluid flow through the second interstitial space.

18. The apparatus of claim 16 wherein the air-handling unit comprises one or more fans positioned within the chamber to either inject air into, or withdraw air from a top end of the first interstitial space and a top end of the second interstitial space.

19. The apparatus of claim 16 wherein the air-handling unit comprises one or more circulation fans positioned within the chamber to either inject air into, or withdraw air from a back end of the first interstitial space and back end of the second interstitial space.

20. The apparatus of claim 16 wherein the air-handling unit comprises a temperature control for regulating the temperature of fluid circulated through the first interstitial space independently from the temperature of fluid circulated through the second interstitial space.

21. The apparatus of claim 16 where in the sealing means comprises a first baffle positioned along a front end of the produce between the two rows of palletized produce and extending from the floor of the room to a top end of the palletized produce, a second baffle positioned along a back end of the palletized produce between the two rows of palletized produce extending from the floor of the room to a top end of the palletized produce, and at least one top baffle positioned in sealing relationship with a top end of the palletized produce and the air handling unit, and the partition is positioned between first baffle and second baffle.

22. A method for storing produce under controlled atmospheric conditions, comprising the steps of:
providing a room having a floor, ceiling, two sidewalls, a rear wall and a door positioned toward a front of the chamber opposite the rear wall;
positioning palletized produce in the room in two rows spaced apart from each other forming an interstitial space, at least a portion of which is between the two rows of palletized produce, and each of the two rows being spaced from the sidewalls forming a fluid circulation space at least a portion of which is between the sidewalls and the two rows of palletized produce;
dividing the interstitial space into a first interstitial and a second interstitial space;
controlling air flow in the room so that air flows between the first interstitial space and fluid circulation space across the palletized produce, and between the second interstitial space and fluid circulation space across the palletized produce; and,
regulating the temperature of air flowing through the first interstitial space independent from the temperature of air flowing through the second interstitial space.

23. The method of claim 22 wherein the step of dividing the interstitial space comprises positioning a partition within the interstitial space wherein the partition is vertically disposed and extends from a front end of the palletized produce to a back end of the palletized produce.

24. The method of claim 22 wherein the step of positioning palletized produce in the ripening room includes positioning a lower tier of two rows of produce on the floor of the ripening room and positioning an upper tier of two rows of produce spaced above the lower tier of produce and the step of dividing the interstitial space comprises positioning a partition within the interstitial space wherein the partition is horizontally disposed between the lower tier and upper tier of two rows of produce and extends from a front end of the palletized produce to a back end of the palletized produce.

25. The method of claim 22 wherein the step of controlling the air flow in the room comprises sealing the first interstitial space and the second interstitial space from the fluid circulation space.

26. The method of claim 25 wherein the step sealing includes the step of sealing a space between the upper tier and lower tier of palletized produce.

27. The method of claim 22 wherein the step of controlling air flow in the room includes the step of injecting air into the first interstitial space and into second interstitial space.

28. The method of claim 22 wherein the step of controlling air flow in the room includes the step of withdrawing air from the first interstitial space and from second interstitial space.
